(19) United States
(12) Patent Application Publication
(10) Pub. No.: US 2002/0127966 A1
(43) Pub. Date: Sep. 12, 2002

(54) Cat odor eliminating system

(76) Inventor: Robert Rich, (US)

Correspondence Address: Richard W. Goldstein, 2071 Clove Road, Staten Island, NY, 10304, US

(21) Appl. No.: 09/805,471

(22) Filed: Mar. 12, 2001

(51) Int. Cl. F24F 7/007

(52) U.S. Cl. 454/341

(57) ABSTRACT

A cat odor eliminating system including a connector having an open inner end, an open outer end, and a hollow interior. A fan is disposed within the connector. A length of tubing is coupled with the open outer end of the connector. The length of tubing has an open free end. An adapter plate is provided that is dimensioned for covering the vented top of the cover of the cat litter box. The adapter plate has a central opening with a collar extending upwardly therefrom. The collar is coupled with the open free end of the length of tubing.

### BACKGROUND OF THE INVENTION

The present invention relates to a cat odor eliminating system and more particularly pertains to allowing odors from a cat litter box to be drawn out of a residence.

Typically, people with cats in their homes provide the cat with a litter box as a place of relieving themselves. When a cat uses the litter box, an odor is typically produced. Most cat owners attempt to frequently change the litter in order to eliminate these odors. However, in order to properly ventilate the cat litter box, the owner would be required to change the litter on a daily basis if not more frequently. Not many cat owners have the time or desire to perform this generally unpleasant task on a consistent basis. Most ventilation devices are complex and expensive. What is needed is a ventilation device that is simple in construction and can be connected to an existing cat litter box so that the odors from the litter box can be expelled out through a clothes dryer output.

The present invention attempts to solve the abovementioned problem by providing a device that will perform these functions.

The use of litter boxes with ventilation systems is known in the prior art. More specifically, litter boxes with ventilation systems heretofore devised and utilized for the purpose of ventilating cat litter boxes are known to consist basically of familiar, expected and obvious structural configurations, notwithstanding the myriad of designs encompasses by the crowded prior art which have been developed for the fulfillment of countless objectives and requirements.

By way of example, U.S. Pat. No. 5,655,478 to Kiera discloses a ventilation system for a litter box capable of being attached to an elbow member of a ventilation pipe. U.S. Pat. No. 5,134,972 to Compagnucci discloses a ventilated litter box assembly comprised of an exhaust duct and fan, attachable to a wall orifice. U.S. Pat. No. 5,140,948 to Roberts discloses a litter box assembly with a fan driven ventilation system.

While these devices fulfill their respective, particular objective and requirements, the aforementioned patents do not describe a cat odor eliminating system for allowing odors from a cat litter box to be drawn out of a residence.

In this respect, the cat odor eliminating system according to the present invention substantially departs from the conventional concepts and designs of the prior art, and in doing so provides an apparatus primarily developed for the purpose of allowing odors from a cat litter box to be drawn out of a residence.

Therefore, it can be appreciated that there exists a continuing need for a new and improved cat odor eliminating system which can be used for allowing odors from a cat litter box to be drawn out of a residence. In this regard, the present invention substantially fulfills this need.

### SUMMARY OF THE INVENTION

In the view of the foregoing disadvantages inherent in the known types of litter boxes with ventilation systems now present in the prior art, the present invention provides an improved cat odor eliminating system. As such, the general purpose of the present invention, which will be described subsequently in greater detail, is to provide a new and improved cat odor eliminating system which has all the advantages of the prior art and none of the disadvantages.

To attain this, the present invention essentially comprises a Y-shaped connector comprised of a central tube and a side tube. The central tube has an open inner end, an open outer end, and a hollow interior. The side tube has an open inner end and an open outer end. The open inner end of the side tube is connected to and is in communication with the hollow interior of the central tube. A fan is disposed within the side tube of the Y-shaped connector. The fan has power switch disposed exteriorly of the side tube. A length of tubing is coupled with the open outer end of the side tube of the Y-shaped connector. The length of tubing has an open free end. An adapter plate is provided that is dimensioned for covering the vented top of the cover of the cat litter box. The adapter plate has a central opening with a collar extending upwardly therefrom. The collar is coupled with the open free end of the length of tubing.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved cat odor eliminating system which has all the advantages of the prior art litter boxes with ventilation systems and none of the disadvantages.

It is another object of the present invention to provide a new and improved cat odor eliminating system which may be easily and efficiently manufactured and marketed.

It is a further object of the present invention to provide a new and improved cat odor eliminating system which is of durable and reliable construction.

An even further object of the present invention is to provide a new and improved cat odor eliminating system which is susceptible of a low cost of manufacture with regard to both materials and labor, and which accordingly is then susceptible of low prices of sale to the consuming public, thereby making such a cat odor eliminating system economically available to the buying public.

Even still another object of the present invention is to provide a new and improved cat odor eliminating system for allowing odors from a cat litter box to be drawn out of a residence.

Lastly, it is an object of the present invention to provide a new and improved cat odor eliminating system including a connector having an open inner end, an open outer end, and a hollow interior. A fan is disposed within the connector. A length of tubing is coupled with the open outer end of the connector. The length of tubing has an open free end. An adapter plate is provided that is dimensioned for covering the vented top of the cover of the cat litter box. The adapter plate has a central opening with a collar extending upwardly therefrom. The collar is coupled with the open free end of the length of tubing.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the cat odor eliminating system constructed in accordance with the principles of the present invention.

FIG. 2 is a perspective view of the present invention illustrated in use.

The same reference numerals refer to the same parts through the various figures.

### DESCRIPTION OF THE PREFERRED EMBODIMENT

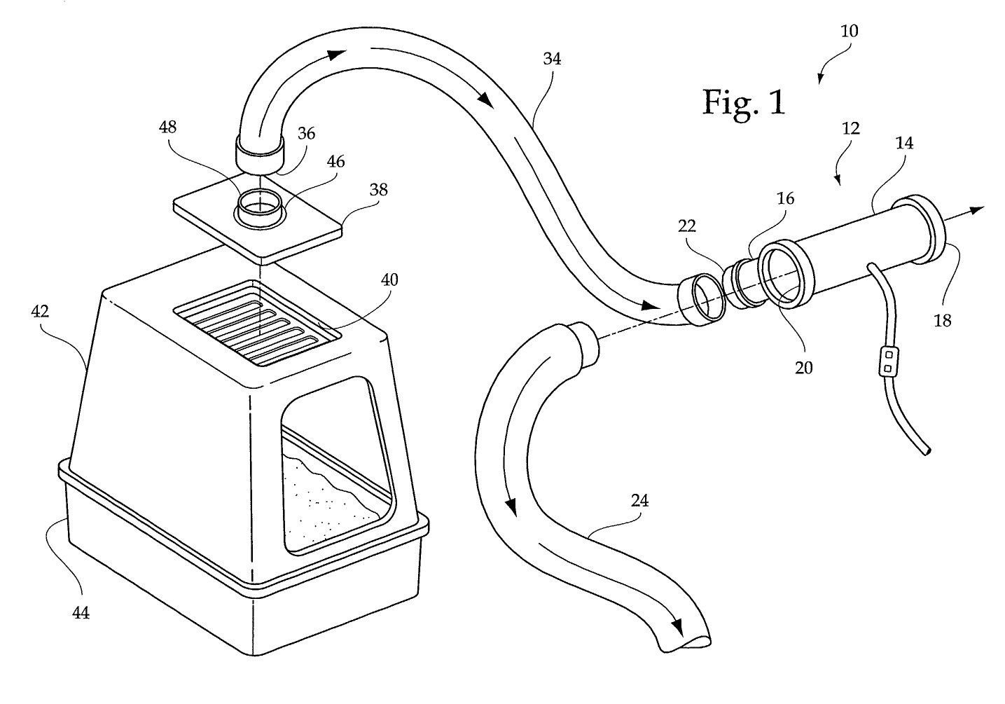

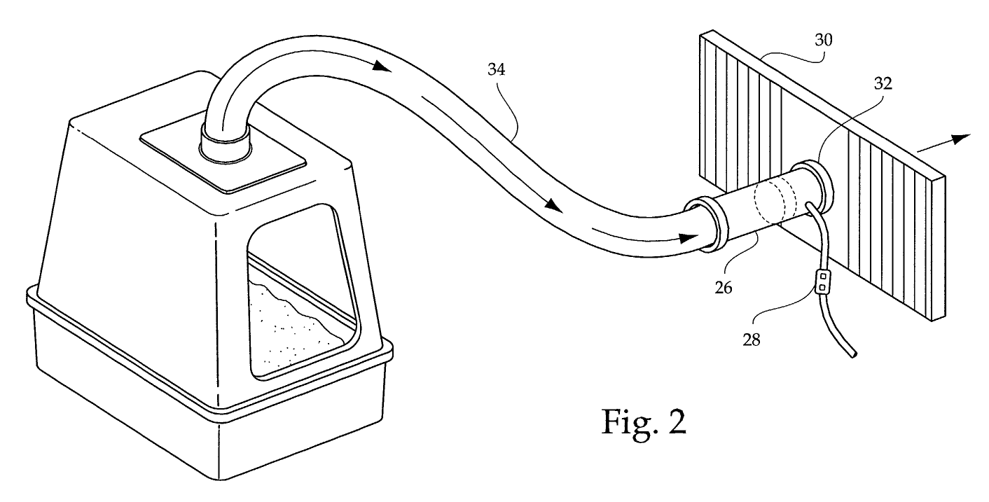

With reference now to the drawings, and in particular, to FIGS. 1 and 2 thereof, the preferred embodiment of the new and improved cat odor eliminating system embodying the principles and concepts of the present invention and generally designated by the reference number 10 will be described.

Specifically, it will be noted in the various figures that the device relates to a cat odor eliminating system for allowing odors from a cat litter box to be drawn out of a residence. In its broadest context, the device consists of a Y-shaped connector, a fan, a length of tubing, and an adapter plate. Such components are individually configured and correlated with respect to each other so as to attain the desired objective.

The Y-shaped connector 12 is comprised of a central tube 14 and a side tube 16. The central tube 14 has an open inner end 18, an open outer end 20, and a hollow interior. The side tube 16 has an open inner end and an open outer end 22. The open inner end of the side tube 16 is connected to and is in communication with the hollow interior of the central tube 14. The Y-shaped connector 12 is designed for use with an existing dryer output vent. The open inner end 18 of the central tube 14 is connected with the dryer output vent while the open outer end 20 is connected with the flexible vent tube 24 that is connected with an air vent of the dryer. Alternately, the Y-shaped connector 12 can be replaced by a standard central tube 14. Note FIG. 2. In this design, the open outer end 18 of the central tube 14 is connected with a window panel 30 that can be secured within an open window. The window panel 30 includes a central opening 32 for coupling with the open outer end 18 of the central tube 14.

The fan 26 is disposed within the side tube 16 of the Y-shaped connector 12. The fan 26 has a power switch 28 disposed exteriorly of the side tube 16. Alternately, as noted in FIG. 2, the fan is disposed within the central tube 14.

The length of tubing 34 is coupled with the open outer end 22 of the side tube 16 of the Y-shaped connector 12. The length of tubing 34 has an open free end 36. Alternately, as illustrated in FIG. 2, the length of tubing 34 can be connected with the open outer end 20 of the central tube.

The adapter plate 38 is dimensioned for covering the vented top 40 of the cover 42 of the cat litter box 44. The adapter plate 38 has a central opening 46 with a collar 48 extending upwardly therefrom. The collar 48 is coupled with the open free end 36 of the length of tubing 34.

In use, the fan 26 when activated, will draw the unpleasant air associated with the cat litter box 44 out through the vented top 40 to be expelled outside either through the dryer output vent or window.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompasses by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A cat odor eliminating system for allowing odors from a cat litter box to be drawn out of a residence, wherein the cat litter box is provided with a cover, the cover having an entrance and a vented top, the system comprising, in combination:
a Y-shaped connector comprised of a central tube and a side tube, the central tube having an open inner end, an open outer end, and a hollow interior, the side tube having an open inner end and an open outer end, the open inner end of the side tube being connected to and in communication with the hollow interior of the central tube;
a fan disposed within the side tube of the Y-shaped connector, the fan having power switch disposed exteriorly of the side tube;
a length of tubing coupled with the open outer end of the side tube of the Y-shaped connector, the length of tubing having an open free end;
an adapter plate dimensioned for covering the vented top of the cover of the cat litter box, the adapter plate having a central opening with a collar extending upwardly therefrom, the collar being coupled with the open free end of the length of tubing.

2. A cat odor eliminating system for allowing odors from a cat litter box to be drawn out of a residence, wherein the cat litter box is provided with a cover, the cover having an entrance and a vented top, the system comprising, in combination:
a connector comprised of a central tube, the central tube having an open inner end, an open outer end, and a hollow interior;
a fan disposed within the side tube of the Y-shaped connector;
a length of tubing coupled with the open outer end of the connector, the length of tubing having an open free end;
an adapter plate dimensioned for covering the vented top of the cover of the cat litter box, the adapter plate having a central opening with a collar extending upwardly therefrom, the collar being coupled with the open free end of the length of tubing.

3. A cat odor eliminating system as set forth in claim 2, wherein the connector is Y-shaped and comprised of a central tube and a side tube, the central tube having an open inner end, an open outer end, and a hollow interior, the side tube having an open inner end and an open outer end, the open inner end of the side tube being connected to and in communication with the hollow interior of the central tube, the length of tubing is coupled with the open outer end of the side tube.

4. A cat odor eliminating system as set forth in claim 2, wherein the fan has power switch disposed exteriorly of the connector.
